(19) United States
(12) Patent Application Publication
(10) Pub. No.: US 2025/0384484 A1
(43) Pub. Date: Dec. 18, 2025

(54) SYSTEMS AND METHODS FOR INJECTING DATA VERIFICATION INTO THIRD-PARTY PORTALS VIA A BROWSER EXTENSION

(71) Applicant: Capital One Services, LLC, McLean, VA (US)

(72) Inventors: Aaron ATTAR, Dallas, TX (US); Rahul NOWLAKHA, Sugar Land, TX (US)

(73) Assignee: Capital One Services, LLC, McLean, VA (US)

(21) Appl. No.: 18/745,231

(22) Filed: Jun. 17, 2024

(51) Int. Cl. G06Q 40/03

(52) U.S. Cl. CPC G06Q 40/03

(57) ABSTRACT

A computer-implemented method is disclosed. The method may include identifying, via a browser extension associated with a first entity and based on content scraped from a portal associated with a second entity different from the first entity, a data requirement associated with an individual for an interaction. The portal may be output on a display of a user device of a third entity different than the first and second entities. The method may include verifying, via the browser extension and by accessing a system associated with the first entity, whether a data element associated with the individual satisfies the data requirement. The method may further include causing, via the browser extension, the display of the user device to output a first visual indication of a result of the verifying.

### TECHNICAL FIELD

Various embodiments of this disclosure relate generally to techniques for data verification, and, more particularly, to systems and methods for injecting data verification into third-party portals via a browser extension.

### BACKGROUND

Many automobile dealers (also referred to herein as “dealers”) use platforms such as websites and portals to facilitate sales, track inventory, and manage finance and insurance processes. For example, a dealer may use a first platform to prepare a credit application for a prospective buyer of a vehicle, and to select a lender to finance (e.g., provide a loan for) the vehicle. Often times, after the dealer selects the lender, the lender will verify the identity and income of the prospective buyer before providing the financing. However, when the dealer selects the lender using the first platform, the dealer may only be able to choose from a limited number or group of lenders whose financial services are integrated within the first platform. To select a lender outside of the group—that is, a lender whose financial services are not integrated in the first platform (also referred to herein as a “different lender” or “other lender”), the dealer may have to remember that a second platform exists for selecting the other lender, and then access the second platform. However, this requires the dealer to leave the first platform, which may provide the dealer's preferred workflow. Further, if the dealer doesn't leave the first platform, the dealer and the prospective buyer may miss out on competitive financing options provided by the other lender, and the other lender may miss out on the financing opportunity.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods for injecting data verification into third-party portals via a browser extension are disclosed. Each of the examples disclosed herein may include one or more features described in connection with any of the other disclosed examples.

In one aspect, an exemplary embodiment of a computer-implemented method may include identifying, via a browser extension associated with a first entity and based on content scraped from a portal associated with a second entity different from the first entity, a data requirement associated with an individual for an interaction, the portal being output on a display of a user device of a third entity different than the first and second entities; verifying in near real time, via the browser extension and by accessing a system associated with the first entity, whether a data element associated with the individual satisfies the data requirement; determining, via the browser extension and by accessing the system associated with the first entity, first information associated with the interaction based on verifying that the data element associated with the individual satisfies the data requirement and based on the second entity; and causing, via the browser extension, the display of the user device to output a first visual indication of a result of the verifying and a second visual indication of the first information associated with the interaction.

In another aspect, an exemplary embodiment of a computer-implemented method may include identifying, via a browser extension associated with a first entity and based on content scraped from a portal associated with a second entity different from the first entity, a data requirement associated with an individual for an interaction, the portal being output on a display of a user device of a third entity different than the first and second entities; verifying, via the browser extension and by accessing a system associated with the first entity, whether a data element associated with the individual satisfies the data requirement; and causing, via the browser extension, the display of the user device to output a first visual indication of a result of the verifying.

In a further aspect, an exemplary embodiment of a system may comprise: a processor; and a memory having programming instructions stored thereon, which, when executed by the processor, causes the system to perform operations comprising: identifying, via a browser extension associated with a first entity and based on content scraped from a portal associated with a second entity different from the first entity, a data requirement associated with an individual for an interaction, wherein: the portal is output on a display of a user device of a third entity different than the first and second entities; and the content scraped from the portal associated with the second entity includes first information associated with the interaction, at least one characteristic of the individual, and at least one characteristic of the interaction; verifying in near real time, via the browser extension and by accessing a system associated with the first entity, whether a data element associated with the individual satisfies the data requirement; determining, via the browser extension and by accessing the system associated with the first entity, second information associated with the interaction based on verifying that the data element associated with the individual satisfies the data requirement and based on the first information and the third entity; and causing, via the browser extension, the display of the user device to output a first visual indication of a result of the verifying and a second visual indication of the second information associated with the interaction.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an example environment, according to one or more embodiments.

FIG. 2A depicts a first example user interface, according to one or more embodiments.

FIG. 2B depicts a second example user interface, according to one or more embodiments.

FIG. 2C depicts a third example user interface, according to one or more embodiments.

FIG. 2D depicts a fourth example user interface, according to one or more embodiments.

FIG. 2E depicts a fifth example user interface, according to one or more embodiments.

FIG. 2F depicts a sixth example user interface, according to one or more embodiments.

FIG. 2G depicts a seventh example user interface, according to one or more embodiments.

FIG. 3 depicts a flowchart of an example method for injecting data verification into third-party portals via a browser extension, according to one or more embodiments.

FIG. 4 depicts an example computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Terms like “provider,” “merchant,” “vendor,” or the like generally encompass an entity or person involved in providing, selling, and/or renting items to persons such as a seller, dealer, renter, merchant, vendor, or the like, as well as an agent or intermediary of such an entity or person. An “item” generally encompasses a service, good, or the like having ownership or other rights that may be transferred. As used herein, terms like “employee” or “user” or “customer” generally encompasses any person or entity that may desire information, resolution of an issue, purchase of a service or product, or engage in any other type of interaction with a provider. The term “browser extension” may be used interchangeably with other terms like “program,” “electronic application,” or the like, and generally encompasses software that is configured to interact with, modify, override, supplement, or operate in conjunction with other software.

In the following description, embodiments will be described with reference to the accompanying drawings. As will be discussed in more detail below, various embodiments, methods, and systems for injecting data verification into third-party portals via a browser extension are described.

In an exemplary use case, an automobile dealer may use a user device, such as a desktop computer, to obtain financing for a prospective buyer of a vehicle (e.g., a new or used vehicle such as a car, truck, motorhome, boat, etc.). More specifically, the dealer may use a browser presented on a display screen of the user device to access a platform (e.g., a website or portal) in which the dealer may enter information about the prospective buyer and the vehicle, for example, and subsequently obtain an offer to finance the vehicle from a first lender.

While viewing or interacting with the platform, a browser extension associated with the browser and a second lender may review and analyze information displayed in the platform (e.g., information regarding the prospective buyer and/or the vehicle, etc.) to determine that the prospective buyer is in need of financing. The browser extension may further identify a requirement associated with the prospective buyer, such as a proof of income requirement, and prompt the dealer to upload such proof (e.g., an electronic version of the prospective buyer's W-2 tax form). In some aspects, the prompt may be provided in a window that is overlaid on, or injected in, the platform displayed on the user device. In some embodiments, the browser extension may verify, in near real time (or real time), whether the W-2 satisfies the proof of income requirement. If the proof of income requirement is satisfied, the browser extension may determine an offer for financing from the second lender based on, for example, information regarding the prospective buyer, the vehicle, the dealer, and/or the offer presented by the first lender. In some embodiments, the browser extension may cause the window to display an indication that the proof of income requirement is satisfied and/or the offer from the second lender. Where the dealer and/or prospective buyer find the offer from the second lender to be more competitive or attractive than the offer from the first lender, the dealer and/or prospective buyer may proceed to select the second lender (e.g., accept or proceed with the offer from the second lender) using the browser extension.

Further, in some embodiments, while the dealer enters information (e.g., information regarding the prospective buyer's name, address, the vehicle, or the like) in the platform, the browser extension may monitor the information being entered and verify or validate the information in near real time (or real time). For example, the browser extension may compare information being entered by the dealer to the content of one or more documents previously uploaded by the dealer using the browser extension (e.g., as proof to satisfy a requirement). Where the browser extension determines that the information entered by the dealer matches the content in the one or more uploaded documents, the browser extension may subsequently notify the dealer (e.g., using the window, window(s), region(s), and/or field(s) of the platform) that the information entered has been verified or validated. Conversely, where the browser extension determines that the information entered by the dealer does not match the content of the one or more uploaded documents, the browser extension may notify the dealer (e.g., using the window, window(s), region(s), and/or field(s) of the platform) that the information entered has not been verified or validated. In addition or in the alternative, the browser extension may compare information being entered by the dealer in the platform to information stored in and/or retrieved from an external database (e.g., a database 120, a database associated with a lender, a database associated with a Department of Motor Vehicles, or the like), to determine whether the information being entered is verified or validated, and notify the dealer of the same. Accordingly, the browser extension may inject data verification into the platform to assist the dealer and expedite a process for obtaining an offer for financing from the second lender, for example. Such verification ensures that information (e.g., personal information of the prospective buyer) is accurate before an offer is made by a lender (e.g., the second lender) and before the dealer submits documentation (e.g., a signed contract) to the lender to accept the offer. Without such verification, the dealer and/or lender (e.g., the second lender) may encounter delays when identifying and/or resolving errors or inaccuracies in the information.

As described above, many dealers currently use financing platforms that allow access to only a limited number or group of lenders. If a given dealer using one of these platforms wishes to select a lender outside of the group, the dealer may have to leave the platform and open a different platform that provides access to the other lender. Otherwise, the dealer and prospective buyer may miss out on a more competitive offer from the other lender. Further, the dealer may miss out on any features provided by the platform into which the other lender is integrated (e.g., a feature for real time or near real time vetting of information of a prospective buyer, vehicle, or the like, where the information is associated with the platform into which the other lender is integrated). However, aspects of the present disclosure provide automated and streamlined processes that allow a dealer to use a financing platform while obtaining one or more financing offers from lenders whose services are not accessible through (or integrated within) the financing platform. Such offers may be more competitive or desirable to the dealer and/or prospective buyer than offers provided by lenders accessible through the platform. Such offers may also be obtained prior to the dealer and/or prospective buyer submitting a contract for financing (and/or one or more documents associated with the contract) to other lenders. In addition, embodiments disclosed herein allow dealers who use a given financing platform to access functionality (e.g., real time or live vetting of information) provided in other platform(s) (e.g., associated with the second lender). Moreover, the processes described herein allow lenders whose services are not integrated within a particular platform to compete for financing opportunities.

While the example above involves a browser extension, it should be understood that techniques according to this disclosure may be adapted to any suitable type of program or technology. It should also be understood that the example above is illustrative only. The techniques and technologies of this disclosure may be adapted to any suitable activity.

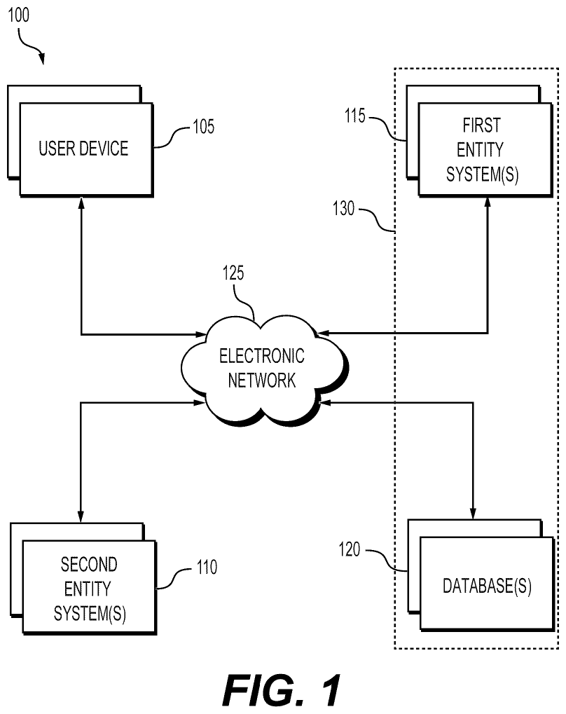

FIG. 1 depicts an example environment 100 that may be utilized with techniques presented herein. One or more user device(s) 105, one or more first entity system(s) 115, one or more database(s) 120, and one or more second entity system(s) 110 may communicate with one another in any arrangement, across an electronic network 125. The user device 105 may be associated with a user who is an employee of, or contractor for, a company or business (e.g., a salesperson or dealer at an automobile dealership), or the like. In some embodiments, the company may be associated with (e.g., own, rent, or control) the user device 105.

The user device 105 may be configured to enable the user to access and/or interact with other systems (e.g., the first entity system(s) 115, the second entity system(s) 110, and/or the database(s) 120) in the environment 100. For example, the user device 105 may be a computer system such as a desktop computer, a laptop, a workstation, a mobile device, a tablet, etc. In some embodiments, the user device 105 may include one or more electronic application(s), such as a program, a platform, a plugin, or a browser extension, installed on a memory of the user device 105. Further, in some embodiments, the user device 105 may be configured to access one or more electronic applications, such as a platform, a website, a portal, a program, a plugin, or a browser extension, via a cloud platform, using the electronic network 125. In some aspects, the user of the user device 105 may facilitate or conduct one or more transactions (e.g., purchases of automobiles, or securing financing for purchases of automobiles) with the first entity system(s) 115, using the electronic network 125. In some embodiments, the user device 105 may be configured to perform methods described in this disclosure.

The first entity system(s) 115 may be a computer system such as a server, a workstation, a desktop computer, a laptop, a mobile device, a tablet, etc. In some examples, the first entity system(s) 115 may be associated with (or include) a cloud computing platform with scalable resources for computation and/or data storage. The first entity system(s) 115 may run one or more applications locally and/or using the cloud computing platform, to perform various computer-implemented methods described in this disclosure. In some embodiments, the first entity system(s) 115 may be associated with (e.g., owned, rented, or controlled by) a company, such as a bank, lender, financing company, or merchant. Further, in some embodiments, the first entity system(s) 115 may be configured to perform methods described in this disclosure.

The database(s) 120 may include computer-readable memory such as a hard drive, flash drive, disk, etc. In some embodiments, the database(s) 120 may include and/or interact with an application programming interface for receiving and/or transmitting data with other systems (e.g., the first entity system(s) 115 and/or the user device 105) of the environment 100. Further, in some embodiments, the database(s) 120 may be associated with (e.g., included in) the first entity system(s) 115, as denoted by the dashed box 130 in FIG. 1. The database(s) 120 may include and/or act as a repository for data received from the user device 105, optionally via the first entity system(s) 115. For example, the database(s) 120 may store one or more data elements (e.g., data representing text, image(s), information, etc.) associated with a platform operated and/or displayed on the user device 105. More specifically, the database(s) 120 may store personal information of a prospective buyer of a vehicle (e.g., the prospective buyer's first, middle, and last names, phone number, address, social security number, credit rating, credit history, stated income, etc.) that a user may enter into the platform. The database(s) 120 may store information associated with the vehicle that the prospective buyer wishes to purchase (e.g., the vehicle's make, model, year, condition, mileage, vehicle identification number (“VIN”), or the like), which the user may enter into the platform. The database(s) 120 may store information associated with the second entity system(s) 110, such as an offer from an entity associated with the second entity system(s) for financing the vehicle. In some embodiments, the database(s) 120 may store information (e.g., one or more offers for financing) associated with one or more additional entity system(s) (not shown in FIG. 1). Further, the database(s) 120 may store other information associated with the platform, such as the name of the user or company using the platform.

The second entity system(s) 110 may be configured to enable an entity (e.g., a bank, lender, financing company, or merchant) associated with the second entity system(s) 110 to interact with the user device 105 in the environment 100. For example, the second entity system(s) 110 may be a computer system such as a server, workstation, desktop computer, a laptop, a mobile device, a tablet, etc. In some embodiments, the second entity system(s) 110 may be configured to interact with a platform operated and/or displayed on the user device 105. For example, the entity associated with the second entity system(s) may use the second entity system(s) and a platform operated on the user device 105 to display one or more offers for financing on a display screen of the user device 105, using the electronic network 125.

In various embodiments, the electronic network 125 may be a wide area network (“WAN”), a local area network (“LAN”), personal area network (“PAN”), or the like. In some embodiments, electronic network 125 includes the Internet, and supports the transmission of information and data between various systems online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like. A web browser may also be referred to herein as a “browser.”

Although depicted as separate components in FIG. 1, it should be understood that a component or portion of a component in the environment 100 may, in some embodiments, be integrated with or incorporated into one or more other components. For example, the database(s) 120 may be integrated into the first entity system(s) 115, as discussed above. In some embodiments, operations or aspects of one or more of the components discussed above may be distributed amongst one or more other components. Any suitable arrangement and/or integration of the various systems and devices of the environment 100 may be used.

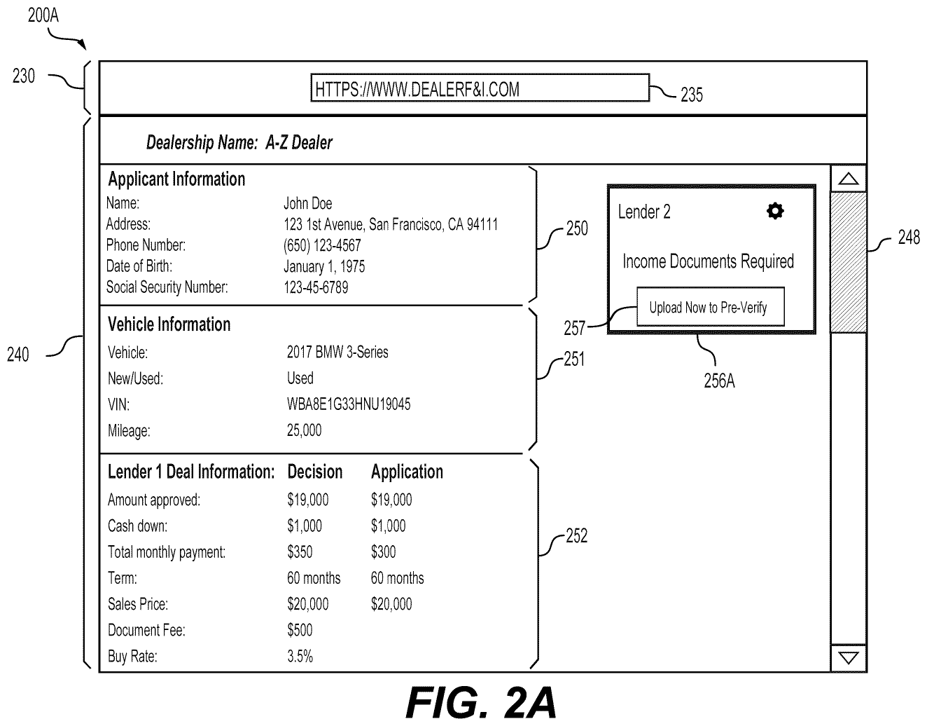

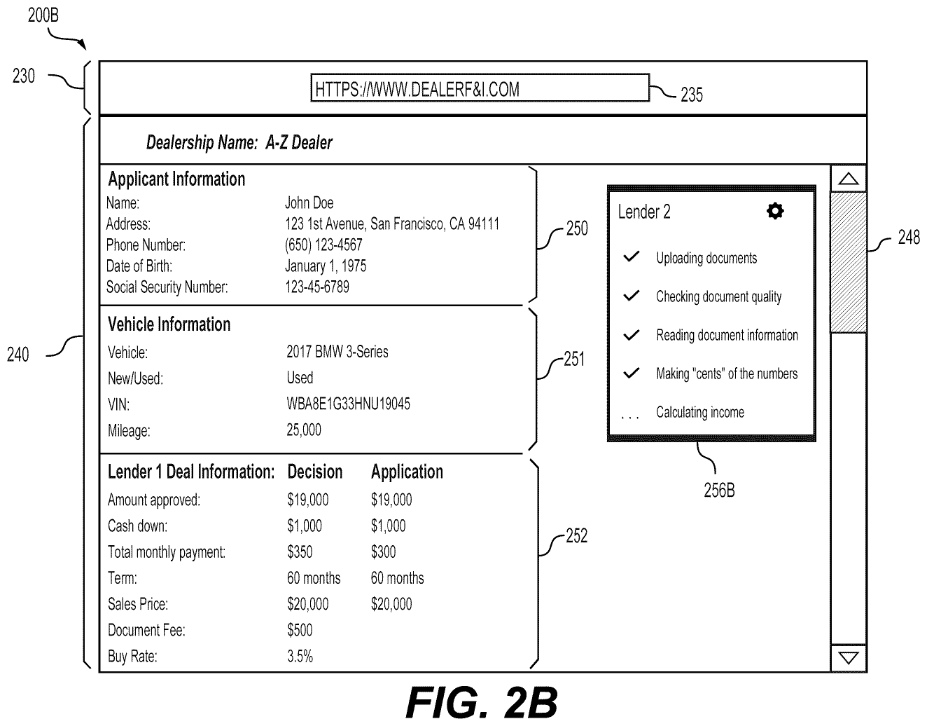

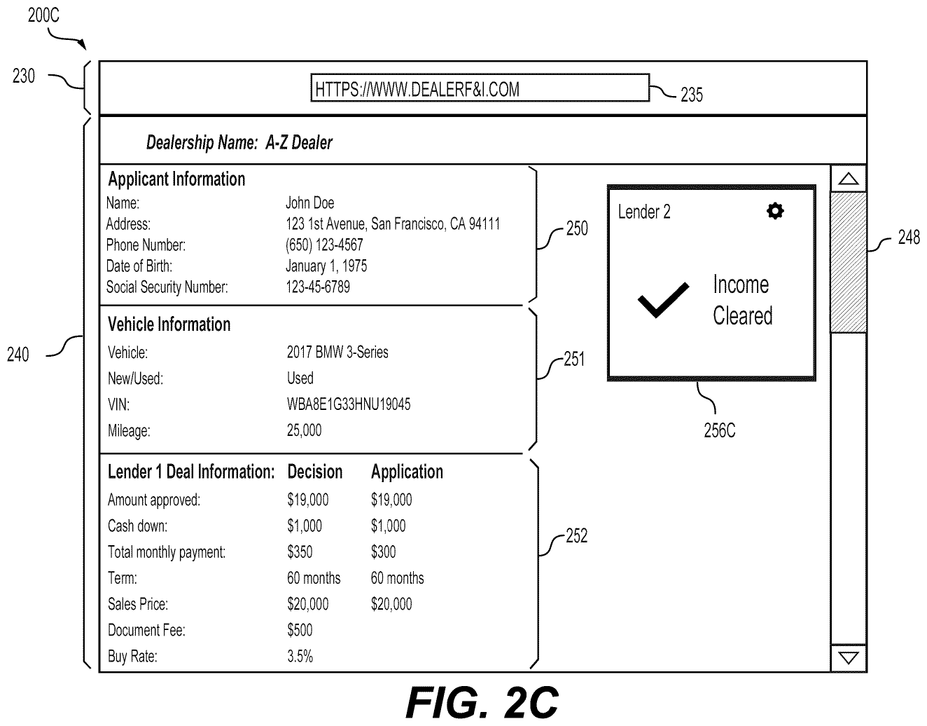

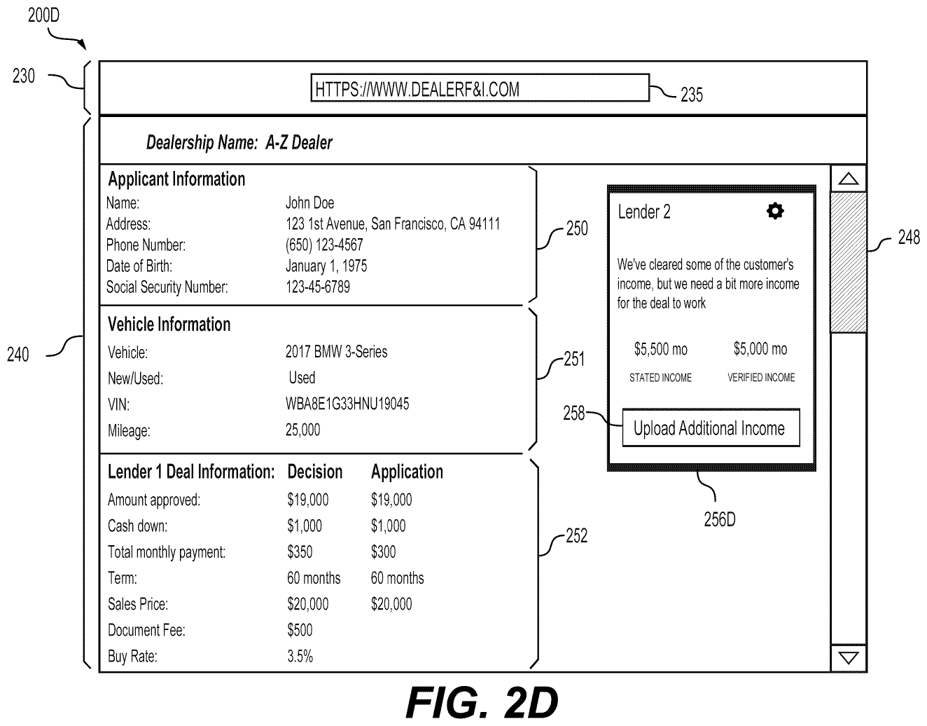

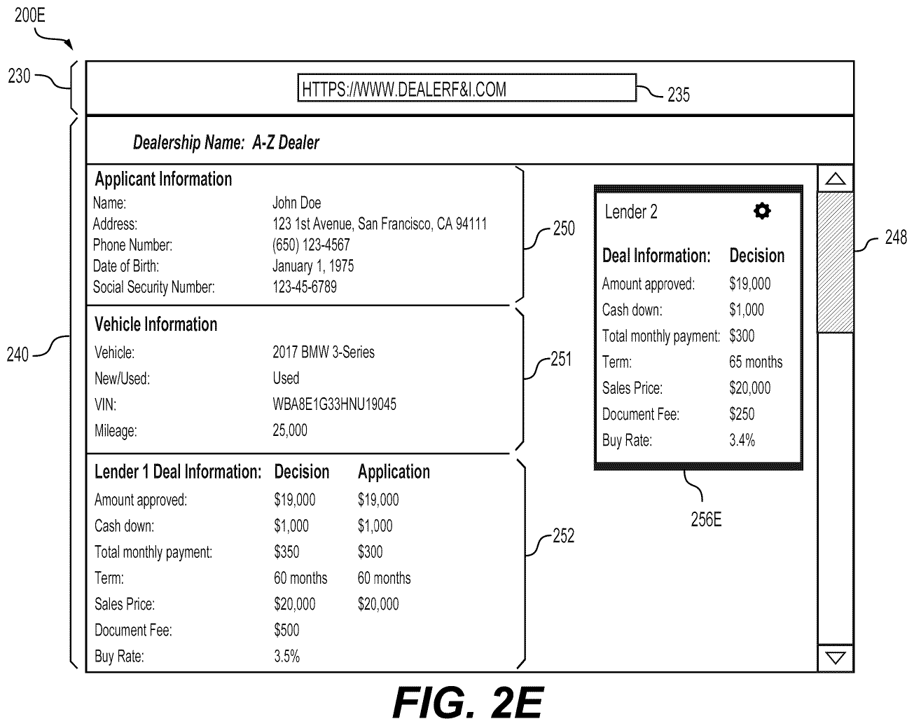

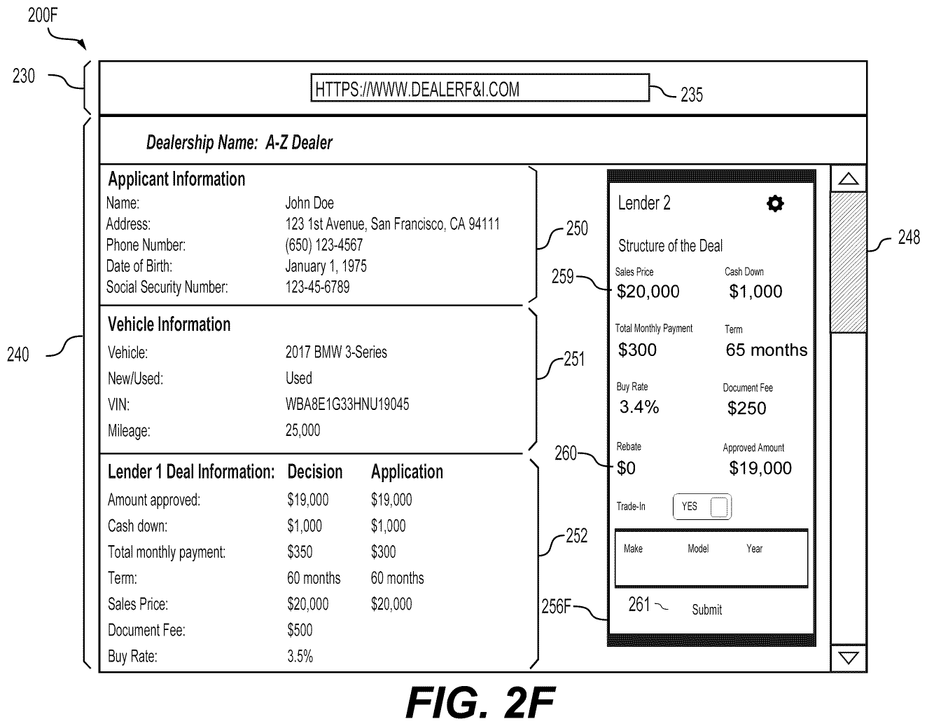

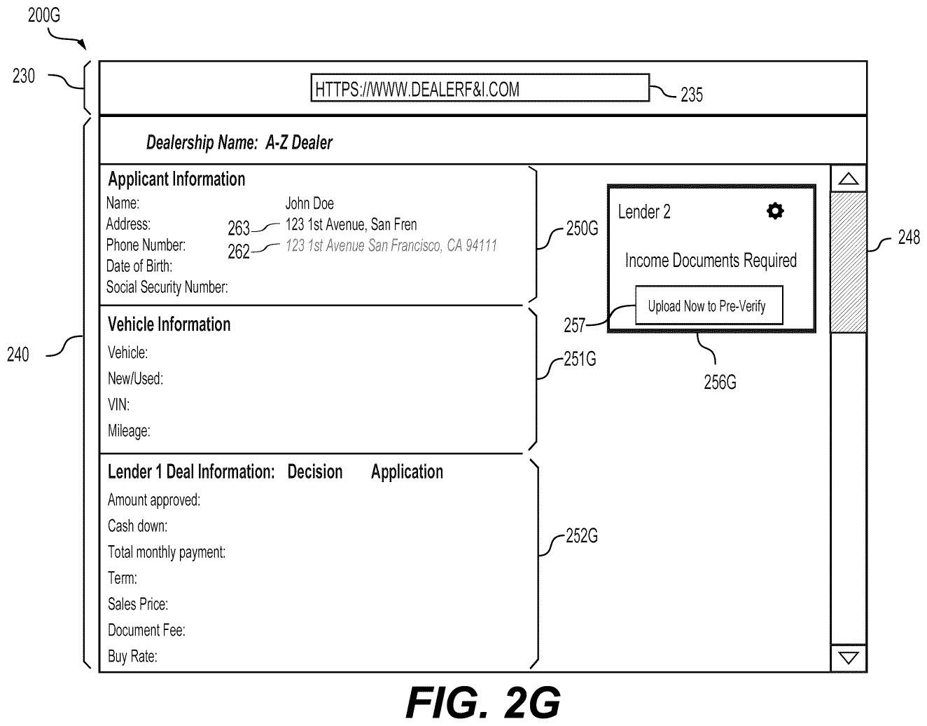

FIG. 2A depicts an example user interface (also referred to herein as a “browser window 200A”) that may be associated with a browser and displayed on the display screen of a user device (e.g., the user device 105 of FIG. 1), according to one or more embodiments. In some embodiments, a user (e.g., a dealer) may view the browser window 200A on a display screen of the user device 105 when seeking financing for a prospective buyer of a vehicle. As shown in FIG. 2A, the browser window 200A includes regions 230 and 240, each of which includes (or is associated with) at least one data element. In some aspects, a data element may be data representing one or more of a field, data entered in a field, a text box, data entered in a text box, a button, a link, a graphic (e.g., an image), an animation, text, a file (e.g., a file including text and/or images), a virtual assistant, a screen-shot of a portion or all of a browser window or webpage, and/or audio data.

As shown in FIG. 2A, the region 230 includes an address bar (or field) 235, in which the dealer may enter a web address (e.g., a uniform resource locator) to visit a website (or web application or platform). For example, the dealer may enter the web address, https://www.dealerf&i.com, in the address bar 235, and then select “enter” on the user device 105. Subsequently, the browser may cause a website corresponding to https://www.dealerf&i.com (e.g., the browser window 200A) to be displayed on the user device 105. In some embodiments, the dealer may visit the website to seek financing and/or insurance for the prospective buyer, facilitate sales of vehicles, and/or track inventory of vehicles.

In some embodiments, the region 240 may include the name of a company for whom the dealer works, such as A-Z Dealer (and/or the name of the dealer), and a scrollbar 248. The region 240 may also include sub-regions 250, 251, and/or 252, for example. In some aspects, the dealer may enter information associated with the prospective buyer (or an applicant for financing) in the sub-region 250. For example, the dealer may enter the prospective buyer's name (e.g., John Doe), address (e.g., 123 1^{st} Avenue, San Francisco, CA 94111), phone number (e.g., (650) 123-4567), date of birth (e.g., Jan. 1, 1975), social security number (e.g., 123-45-6789), and/or the like, in the sub-region 250. The dealer may further enter information associated with the vehicle that the prospective buyer wishes to purchase, in the sub-region 251. For example, the dealer may enter information such as the vehicle's year, make, and model (e.g., 2017 BMW 3-Series), condition (e.g., whether the vehicle is new or used), VIN (e.g., WBA8E1G33HNU19045), mileage (e.g., 25,000), and/or the like, in the sub-region 251. Further, the dealer may enter information associated with the prospective buyer's needed or desired financing, in the sub-region 252. For example, under the heading “Application” in the sub-region 252, the dealer may enter information such as a desired amount of financing (e.g., $19,000), an amount of cash down the prospective buyer is willing or able to provide (e.g., $1,000), a desired total monthly payment ($300), a desired term of a loan (e.g., 60 months), a sales price of the vehicle (e.g., $20,000) and/or other information (not shown in FIG. 2A) such as a stated income, a credit score or rating, a rebate amount, an interest rate, a buy rate, a value and/or type of insurance sought, a value of a vehicle being traded-in, and/or the like.

In some embodiments, after entering one or more data elements in the sub-regions 250, 251, and/or 252, an entity (e.g., lender 1) associated with the second entity system(s) 110 (and whose financial services are integrated in the website or platform) may prepare and cause the website to output information associated with an offer for financing the vehicle, in the sub-region 252. For example, lender 1 may cause the website to display, under the header “Decision” in the sub-region 252, an approved amount (e.g., $19,0000), a confirmation of the cash down (e.g., $1,000), a total monthly payment (e.g., $350), a term of a loan (e.g., 60 months), a confirmation of the sales price of the vehicle (e.g., $20,000), a document fee (e.g., $500), a buy rate (e.g., 3.5%), and/or the like. In some aspects, lender 1 's offer may include terms that are the same or different from those sought by the prospective buyer. For example, as shown in the sub-region 252 of FIG. 2A, the prospective buyer sought a monthly payment of $300 while lender 1 provided an offer based on a monthly payment of $350.

In some embodiments, before or while viewing the browser window 200A, the dealer may log in (e.g., enter a user name and/or password or the like) to a browser extension that is associated with the browser operating on the user device 105. In some aspects, the browser extension may also be associated with the entity (e.g., lender 2) associated with the first entity system(s) 115 (and whose financial services are not integrated in the website or platform) and/or the database(s) 120. Further, the browser extension may include a sub-region (or window) 256A, within the region 240 of the browser window 200A, as shown in FIG. 2A. In some aspects, the browser extension may be configured to facilitate (or provide) financing for the prospective buyer and/or the dealer from lender 2.

In some embodiments, the browser extension may cause the sub-region 256A to be displayed upon determining that the dealer and/or prospective buyer seek financing to purchase the vehicle. In some aspects, the browser extension may be configured to determine that the dealer and/or prospective buyer seek financing by extracting (e.g., scraping) and analyzing one or more data elements displayed in the browser window 200A. For example, the browser extension may extract and analyze data regarding the prospective buyer displayed (or entered) in the sub-region 250; data regarding the vehicle displayed (or entered) in the sub-region 251; data regarding financing that the prospective buyer seeks, displayed (or entered) under the “Application” header in the sub-region 252; and/or data regarding one or more offers for financing provided by one or more lenders whose financial services are integrated in the website or platform (e.g., lender 1), displayed in the sub-region 252.

In some aspects, the sub-region 256A may include content configured prompt the dealer to seek an offer for financing from the entity (e.g., lender 2) associated with the first entity system(s) 115 (whose financial services are not integrated in the website or platform). For example, in some embodiments, the sub-region 256A may include a message indicating that if the dealer selects (or uses) lender 2 via the browser extension, lender 2 may pre-clear (e.g., pre-approve) the prospective buyer for financing in near real time (or real time), prior to the dealer submitting a contract and any associated documentation for the financing to the first entity system(s) 115. In addition or in the alternative, the sub-region 256A may include a message indicating that if the dealer selects (or uses) lender 2 via the browser extension, lender 2 may include a particular interest rate or buy rate as part of a financing offer.

In addition or in the alternative, the browser extension may identify requirement(s) associated with a potential offer for financing from lender 2 based on data extracted from the browser window 200A, and subsequently cause the sub-region 256A to display a message prompting the dealer to provide one or more documents to satisfy the requirement(s). For example, where the browser extension analyzes (e.g., identifies) one or more data elements scraped from the browser window 200A, such as the prospective buyer's name, stated income (not shown in FIG. 2A), and/or the vehicle the prospective buyer wishes to purchase, the browser extension may identify (or determine) one or more requirements that must be satisfied for the prospective buyer to be pre-cleared by lender 2. The one or more requirements may include, for example, submission of (i) proof of one or more of the following: the prospective buyer's identity (e.g., a driver's license, passport, or other form of identification), address (e.g., a copy of bill sent to the prospective buyer's residence), phone number, date of birth (e.g., birth certificate), social security number (e.g. social security card), stated income (e.g., a W-2 tax form or payroll stub); and/or (ii) a credit report or credit rating associated with the prospective buyer, or the like. In some embodiments, the browser extension may identify a requirement for proof of income based on analyzing one or more data elements in the browser window 200A, and subsequently cause sub-region 256A to indicate, “Income Documents Required,” and display a button 257 labeled, “Upload Now to Pre-Verify,” as shown in FIG. 2A. In some aspects, the dealer may select (or click) the button 257 to begin uploading one or more documents to prove the prospective buyer's income.

In some embodiments, the one or more documents (or other documents related to, for example, the prospective buyer's address, driving record, or the like) to be uploaded by the dealer may be obtained (or retrieved) from one or more of the following sources: (i) the prospective buyer; (ii) the entity associated with the first entity system(s) 115 (e.g., lender 2, who may already have information regarding the prospective buyer if the prospective buyer is a customer of lender 2 and/or has a credit card issued by lender 2); (iii) the database(s) 120; and/or (iv) other database(s) of public agencies (e.g., the Department of Motor Vehicles), credit agencies, or the like.

After uploading the one or more documents, the browser extension may begin to analyze the one or more documents to determine the quality (e.g., readability) of the one or more documents; read (e.g., interpret) information in the one or more documents; and/or determine whether the one or more documents satisfy the proof of income requirement (collectively, the “analysis”). With reference to FIG. 2B, in some embodiments, the browser extension may cause a sub-region 256B in a browser window 200B to provide status of this analysis. The sub-region 256B and browser window 200B may be embodiments of the sub-region 256A and browser window 200A of FIG. 1, respectively. Further, in some embodiments, the browser extension may transmit the one or more uploaded documents to the first entity system(s) 115 and/or the database(s) 120, which may perform the analysis (optionally using the browser extension). For example, the first entity system(s) 115 may determine the quality and content of the one or more documents, and compare the content (and/or format of the content) of the one or more documents to (i) information displayed in the browser window 200B and/or (ii) information stored in and/or retrieved from the database(s) 120. In some aspects, the information stored in and/or retrieved from the database(s) 120 may include data elements scraped from the browser window 200B and/or other information. The other information may include, for example, personal, identification, and/or financial information of the prospective buyer obtained from lender 2 (if the prospective buyer is already a customer of the lender 2), and/or other sources such as other databases, applications, and/or systems.

In some embodiments, where the browser extension and/or the first entity system(s) 115 determine that the content (and/or formatting of the content) of the one or more documents matches that of the data element(s) scraped from the browser window 200B and/or the database(s) 120, the browser extension and/or the first entity system(s) 115 may determine that the proof of income requirement is satisfied. With reference to FIG. 2C, the browser extension may subsequently cause a sub-region 256C of a browser window 200C to indicate, for example, “Income Cleared,” or that the prospective buyer is pre-approved for financing from lender 2. While not shown in FIG. 2C, in some embodiments where the browser extension and/or the first entity system(s) 115 determine that one or more other requirements (e.g., for proof of identity, address, phone number, date of birth, social security number, or the like) are satisfied, the browser extension may cause the sub-region 256C (and/or other sub-regions and/or fields) of the browser window 200C to indicate that such requirements are satisfied. Put differently, in some embodiments where the browser extension and/or the first entity system(s) 115 determine that personal information of the prospective buyer is validated or verified, the browser extension may cause the sub-region 256C (and/or other sub-regions and/or fields) of the browser window 200C to indicate that such information is validated or verified.

In some embodiments, the sub-region 256C may be injected into the website or browser window 200C. In some other embodiments, the sub-region 256C may be overlaid on the website or browser window 200C. The sub-region 256C and the browser window 200C may be embodiments of the sub-region 256B and the browser window 200B of FIG. 2B, respectively.

Where the browser extension and/or the first entity system(s) 115 determine that the content (and/or formatting of the content) of the one or more documents uploaded by the dealer does not match that of the data element(s) scraped from the browser window 200B and/or the database(s) 120, the browser extension and/or first entity system(s) 115 may determine that the proof of income requirement is not satisfied. For example, with reference to FIG. 2D, the browser extension may subsequently cause a sub-region 256D of a browser window 200D to indicate, for example, “We've cleared some of the customer's income, but we need a bit more income for the deal to work,” and that the prospective buyer's stated income is $5,500 per month, while the income verified by the browser extension and/or the first entity system(s) 115 is only $5,000 per month. The sub-region 256D and the browser window 200D may be embodiments of the sub-region 256C and the browser window 200C of FIG. 2C, respectively. As shown in FIG. 2D, the browser extension may further cause the sub-region 256D to display a button 258, which the dealer may select to upload one or more additional documents to provide proof of the prospective buyer's income. In embodiments where the browser extension and/or the first entity system(s) 115 are not able to read the content of the one or more documents uploaded by the dealer, the browser extension may cause the sub-region 256D to display an indication that the one or more documents cannot be read (or are of insufficient quality), and prompt the dealer to upload one or more alternative documents of higher quality (not shown in FIG. 2D).

In some embodiments where the browser extension and/or the first entity system(s) 115 determine (or verify) that the income requirement is satisfied (and/or that one or more other requirements are satisfied), the browser extension and/or the first entity system(s) 115 may determine an offer for financing for the prospective buyer. More specifically, the browser extension and/or the first entity system(s) 115 may determine the offer based on information associated with the prospective buyer, the vehicle, the dealer, and/or one or more offers provided by lender(s) whose financial services are integrated in the platform (e.g., lender 1). With reference to FIG. 2E, the information associated with the prospective buyer may include, for example, information displayed in the sub-region 250, information displayed under the “Application” header of the sub-region 252, and/or any other information associated with the prospective buyer stored in and/or retrieved from the database(s) 120. The information associated with the vehicle may include, for example, information displayed in the sub-region 251 and/or information associated with the vehicle stored in and/or retrieved from the database(s) 120. The information associated with the dealer may include, for example, an identity of the dealer and/or the dealer's employer, and/or a rate and/or fee associated with the dealer and/or the dealer's employer, which may be obtained from a browser window 200E, the database(s) 120 and/or other sources. The browser window 200E may be an embodiment of the browser window 200D of FIG. 2D. The rate and/or fee associated with the dealer (and/or the dealer's employer) may represent compensation the dealer (and/or the dealer's employer) will receive if the dealer selects lender 2 as the lender (e.g., accepts an offer for financing from lender 2). The information associated with the one or more offers provided by lender(s) whose financial servers are integrated in the platform (e.g., lender 1) may include information displayed under the “Decision” header of the sub-region 252. In some embodiments, the browser extension and/or the first entity system(s) 115 may generate the offer such that the offer includes one or more terms and/or conditions that may be more competitive or attractive to the prospective buyer and/or dealer than those provided by the lender(s) whose services are integrated in the platform (e.g., lender 1). For example, the generated offer may include a lower interest rate, a lower buy rate, a lower monthly payment, a lower document fee, a higher rate or fee for the dealer, and/or other terms or conditions.

Once the browser extension and/or the first entity system(s) 115 have generated the offer, the browser extension may cause the sub-region 256E to display the offer. For example, the sub-region 256E may display an offer that includes an approved amount of $19,000, a confirmation of $1,000 cash down, a total monthly payment of $300, a term of 65 months, a confirmation of a sales price of $20,000, a document fee of $250, and a buy rate of 3.4%. The dealer and/or prospective buyer may subsequently decide whether to accept the offer from lender 2.

With reference to FIG. 2F, in some other embodiments, the browser extension may cause a sub-region 256F of a browser window 200F to display an offer in an interactive or adjustable manner. The sub-region 256F and the browser window 200F may be embodiments of the sub-region 256E and the browser window 200E of FIG. 2E, respectively, for example. As shown in FIG. 2F, the sub-region 256F may display each of one or more terms of the offer in a respective field (e.g., a field 259 for the sales price and a field 260 for a rebate). However, in some embodiments, the dealer may potentially modify the offer by adjusting one or more terms in the various fields of the sub-region 256F (including, for example, by indicating the make, model and year of any vehicle to be traded in by the prospective buyer), and then selecting a submit button 261. After selecting the submit button 261, the browser extension and/or the first entity system(s) 115 may analyze the one or more adjusted terms in the sub-region 256F, and determine whether a new or updated offer is feasible (or acceptable) by lender 2 based on the one or more adjusted terms. If the new offer is feasible, the browser extension may cause the sub-region 256E to output the new offer (not shown in FIG. 2F).

Further, in some embodiments, the browser extension may be configured to assist the dealer with entering information in a browser window. For example, with reference to FIG. 2G, as the dealer enters an address for the prospective buyer in a field 263 of a sub-region 250G, the browser extension and/or the first entity system(s) 115 may compare the address being entered to data stored in the database(s) 120 and/or other sources. Subsequently, the browser extension and/or the first entity system(s) 115 may (i) determine that address being entered is incorrect, (ii) predict the full address being entered; and/or (iii) determine a more accurate version of the address being entered. Accordingly, the browser extension may cause a field 262 of the sub-region 250G to display the corrected, predicted, and/or more accurate version of the address. While the foregoing example pertains to the prospective buyer's address, the browser extension may be configured to assist the dealer with entering any information in the browser window 200G (e.g. in the sub-region 250G, the sub-region 251G, a sub-region 252G, and/or the sub-region 250G). The sub-regions 250G, 251G, 252G, and 256G may embodiments of the sub-regions 250, 251, 252, and 256F, respectively, of FIG. 2F. Further, the browser window 200G may be an embodiment of the browser window 200F of FIG. 2F. It is noted that the content, size, and/or position of the browser windows 200A-200G (including the sub-regions therein) of FIGS. 2A-2G are merely examples. Further, the techniques and technologies of this disclosure may be adapted to any suitable user interface or browser window.

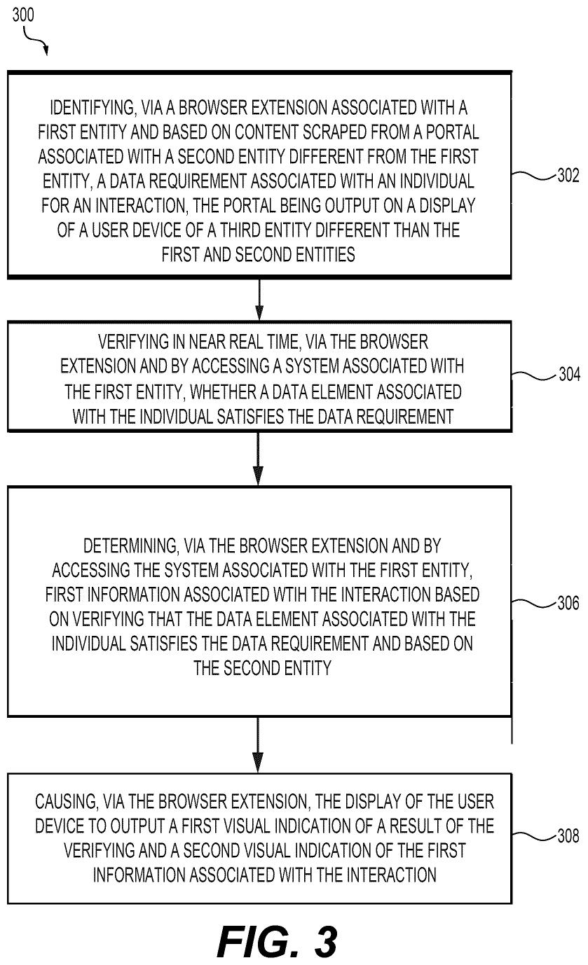

FIG. 3 is a flowchart illustrating a method 300 for injecting data verification into a third-party portal via a browser extension, according to one or more embodiments of the present disclosure. In some aspects, the browser extension and the third-party portal may be embodiments of the browser extension and website, respectively, discussed above with reference to FIGS. 2A-2G. In some embodiments, the method 300 may be performed by (or using) the browser extension, the first entity system(s) 115, and/or the database(s) 120.

As shown in FIG. 3, the method 300 may include identifying, via a browser extension associated with a first entity and based on content scraped from a portal associated with a second entity different from the first entity, a data requirement associated with an individual. The portal may be output on a display of a user device of a third entity different than the first and second entities (302). In some embodiments, the first entity may be the entity associated with the first entity system(s) 115 and/or lender 2, and the second entity may be the entity associated with the second entity system(s) 110 and/or lender 1. The portal may be associated with the second entity by, for example, displaying or being configured to display one or more offers for financing provided by the second entity. The individual may be a prospective buyer (e.g., of a vehicle), and the interaction may represent a potential offer (e.g., a potential loan) for financing (e.g., the vehicle) desired by the individual and/or a third entity (e.g., a dealer or employer of a dealer). The data requirement may represent, for example, submission of (i) proof of one or more of the following: the prospective buyer's identity (e.g., a driver's license, passport, or other form of identification), address (e.g., a copy of bill sent to the prospective buyer's residence), phone number, date of birth (e.g., birth certificate), social security number (e.g. social security card), stated income (e.g., a W-2 tax form or payroll stub); and/or (ii) a credit report or credit rating associated with the prospective buyer, or the like. The content scraped from the portal may include second information (e.g., an offer from lender 1) associated with the interaction. Further, the content scraped from the portal may include at least one characteristic of the individual (e.g., the prospective buyer's information displayed or entered in the sub-region 250) and at least one characteristic of the interaction (e.g., information regarding the vehicle displayed or entered in the sub-region 251 or information regarding the prospective buyer's desired financing or lender 1's offer displayed in the sub-region 252). The user device may represent the user device 105.

The method 300 may further include verifying in near real time, via the browser extension and by accessing a system associated with the first entity, whether a data element associated with the individual satisfies the data requirement (304). In some embodiments, the data element may include (or represent) a scanned image or electronic copy of an article, where the article may include a physical document, a physical photo identification article (e.g., a physical driver's license, a physical passport, a physical identification card, etc.), a physical bill (including a prospective buyer's address, for example), a physical birth certificate, a physical social security card, a physical credit report, and/or the like. The system associated with the first entity may include the first entity system(s) 115, for example.

Further, in some embodiments, verifying whether the data element associated with the individual satisfies the data requirement may include verifying that the contents of the document satisfy predetermined criteria. The predetermined criteria may include, for example, determining that the data element matches corresponding data or information (e.g., data presented in the browser window 200A and/or stored in or retrieved from the database(s) 20); determining that the data element is genuine or authenticated; determining that the data element proves that the individual has an income that meets or exceeds a threshold; and/or determining that the data element proves that the individual is of an age that meets or exceeds a threshold). Further, in some embodiments, verifying whether the data element associated with the individual satisfies the data requirement may include verifying whether a formatting of data in the data element matches a corresponding formatting. The formatting of data in the data element may refer to an organization, structure, font, size, angle, color, position, and/or spacing of data in the data element, and/or any delimiters used to separate data in the data element.

The method 300 may further include determining, via the browser extension and by accessing the system associated with the first entity, first information associated with the interaction based on verifying that the data element associated with the individual satisfies the data requirement and based on the second entity (306). In some aspects, the first information may represent one or more (e.g., all) terms and/or conditions of an offer for financing provided by the entity associated with the first entity system(s) 115 and/or lender 2. In some embodiments, determining the first information associated with the interaction may be further based on the third entity (e.g., the dealer or the dealer's employer). Further, in some embodiments, determining the first information associated with the interaction may further be based on determining that (i) the formatting of the data in the data element matches the corresponding formatting and (ii) the data element matches the corresponding data.

The method 300 may further include causing, via the browser extension, the display of the user device to output a first visual indication of a result of the verifying and a second visual indication of the first information associated with the interaction (308). In some embodiments, the first visual indication of the result of the verifying may represent, for example, the content of the sub-region 256C or 256D. Further, the first visual indication of the result of the verifying may include an indication that the data element associated with the individual satisfies the data requirement. The second visual indication of the first information associated with the interaction may represent, for example, the content of the sub-region 256E or 256F. Further, in some embodiments, the step 308 of the method 300 may include causing, via the browser extension, the display of the user device to output the first visual indication of the result of the verifying prior to the second visual indication of the first information associated with the interaction.

Accordingly, the method 300 provides an automated and streamlined process that allows a third entity (e.g., a dealer) to use a financing platform (e.g., a third-party portal or website) while obtaining one or more financing offers from lenders whose services are not accessible through (or integrated within) the financing platform (e.g., lender 2). Such offers may be more competitive or attractive to the dealer and/or prospective buyer than offers provided by lenders accessible through the platform (e.g., lender 1). Such offers (and/or indications of a data requirement being satisfied) may also be obtained prior to the dealer and/or prospective buyer submitting a contract for financing (or one or more documents associated with the contract) to lender 2. Moreover, the processes described herein allow lenders whose services are not integrated within a particular platform to compete for financing opportunities.

In general, any process or operation discussed in this disclosure that is understood to be computer-implementable, such as the process illustrated in FIG. 3, may be performed by one or more processors of a computer system, such as any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

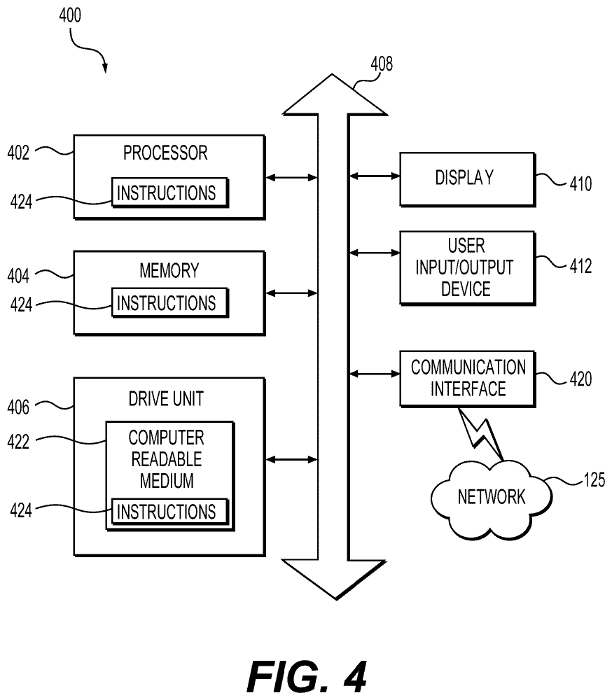

FIG. 4 is a simplified functional block diagram of a computer 400 that may be configured as a device for executing the method of FIG. 3, according to exemplary embodiments of the present disclosure. For example, the computer 400 may be configured as the first entity system(s) 115 or the user device 105, according to exemplary embodiments of this disclosure. In some embodiments, the computer 400 may be configured as the second entity system(s) 110, according to exemplary embodiments of this disclosure. In various embodiments, any of the devices or systems herein may be a computer 400 including, for example, a data communication interface 420 for packet data communication. The computer 400 also may include a central processing unit (“CPU”) 402, in the form of one or more processors, for executing program instructions. The computer 400 may include an internal communication bus 408, and a storage unit 406 (such as ROM, HDD, SDD, etc.) that may store data on a computer readable medium 422, although the computer 400 may receive programming and data via network communications. The computer 400 may also have a memory 404 (such as RAM) storing instructions 424 for executing techniques presented herein, although the instructions 424 may be stored temporarily or permanently within other modules of computer 400 (e.g., processor 402 and/or computer readable medium 422). The computer 400 also may include input and output ports 412 and/or a display (or display screen) 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method, comprising:
identifying, via a browser extension associated with a first entity and based on content scraped from a portal associated with a second entity different from the first entity, a data requirement associated with an individual for an interaction, the portal being output on a display of a user device of a third entity different than the first and second entities;
verifying in near real time, via the browser extension and by accessing a system associated with the first entity, whether a data element associated with the individual satisfies the data requirement;
determining, via the browser extension and by accessing the system associated with the first entity, first information associated with the interaction based on verifying that the data element associated with the individual satisfies the data requirement and based on the second entity; and
causing, via the browser extension, the display of the user device to output a first visual indication of a result of the verifying and a second visual indication of the first information associated with the interaction.

2. The computer-implemented method of claim 1, wherein the content scraped from the portal associated with the second entity includes second information associated with the interaction, and wherein determining the first information associated with the interaction is further based on the second information.

3. The computer-implemented method of claim 2, wherein determining the first information associated with the interaction is further based on the third entity.

4. The computer-implemented method of claim 3, wherein the content scraped from the portal associated with the second entity further includes:
at least one characteristic of the individual; and
at least one characteristic of the interaction.

5. The computer-implemented method of claim 1, wherein the data element includes a scanned image or electronic copy of an article.

6. The computer-implemented method of claim 5, wherein the article includes a physical photo identification article.

7. The computer-implemented method of claim 1, wherein causing, via the browser extension, the display of the user device to output the first visual indication of the result of the verifying and the second visual indication of the first information associated with the interaction, comprises:
causing, via the browser extension, the display of the user device to output the first visual indication of the result of the verifying prior to the second visual indication of the first information associated with the interaction.

8. The computer-implemented method of claim 1, wherein the data element includes an electronic copy or a scanned image of a document, and wherein verifying whether the data element associated with the individual satisfies the data requirement includes verifying that contents of the document satisfy predetermined criteria.

9. The computer-implemented method of claim 1, wherein verifying whether the data element associated with the individual satisfies the data requirement includes verifying whether a formatting of data in the data element matches a corresponding formatting.

10. The computer-implemented method of claim 9, wherein verifying whether the data element associated with the individual satisfies the data requirement further includes verifying whether the data element matches corresponding data.

11. The computer-implemented method of claim 10, wherein determining the first information associated with the interaction is further based on determining that the formatting of the data in the data element matches the corresponding formatting, and on determining that the data element matches the corresponding data.

12. The computer-implemented method of claim 11, wherein the first visual indication of the result of the verifying includes an indication that the data element associated with the individual satisfies the data requirement.

13. A computer-implemented method, comprising:
identifying, via a browser extension associated with a first entity and based on content scraped from a portal associated with a second entity different from the first entity, a data requirement associated with an individual for an interaction, the portal being output on a display of a user device of a third entity different than the first and second entities;
verifying, via the browser extension and by accessing a system associated with the first entity, whether a data element associated with the individual satisfies the data requirement; and
causing, via the browser extension, the display of the user device to output a first visual indication of a result of the verifying.

14. The computer-implemented method of claim 13, further comprising:
determining, via the browser extension and by accessing the system associated with the first entity, first information associated with the interaction based on verifying that the data element associated with the individual satisfies the data requirement and based on the second entity.

15. The computer-implemented method of claim 14, further comprising:
causing, via the browser extension, the display of the user device to output a second visual indication of the first information associated with the interaction.

16. The computer-implemented method of claim 15, wherein verifying whether the data element associated with the individual satisfies the data requirement comprises:
verifying, in near real time, whether the data element associated with the individual satisfies the data requirement.

17. The computer-implemented method of claim 16, wherein the content scraped from the portal associated with the second entity includes second information associated with the interaction, and wherein determining the first information associated with the interaction is further based on the second information.

18. The computer-implemented method of claim 17, wherein determining the first information associated with the interaction is further based on the third entity.

19. The computer-implemented method of claim 18, wherein the content scraped from the portal associated with the second entity further includes:
at least one characteristic of the individual; and
at least one characteristic of the interaction.

20. A system, comprising:
a processor; and
a memory having programming instructions stored thereon, which, when executed by the processor, causes the system to perform operations comprising:
identifying, via a browser extension associated with a first entity and based on content scraped from a portal associated with a second entity different from the first entity, a data requirement associated with an individual for an interaction, wherein:
the portal is output on a display of a user device of a third entity different than the first and second entities; and
the content scraped from the portal associated with the second entity includes first information associated with the interaction, at least one characteristic of the individual, and at least one characteristic of the interaction;
verifying in near real time, via the browser extension and by accessing a system associated with the first entity, whether a data element associated with the individual satisfies the data requirement;
determining, via the browser extension and by accessing the system associated with the first entity, second information associated with the interaction based on verifying that the data element associated with the individual satisfies the data requirement and based on the first information and the third entity; and
causing, via the browser extension, the display of the user device to output a first visual indication of a result of the verifying and a second visual indication of the second information associated with the interaction.
